(19) United States
(12) Patent Application Publication
(10) Pub. No.: US 2017/0025838 A1
(43) Pub. Date: Jan. 26, 2017

(54) INTERNAL CONDUCTIVE ELEMENT FOR BONDING STRUCTURAL ENTITIES

(71) Applicants: Justin Stewart, Deerfield Beach, FL (US); Edward P. Ellers, Boca Raton, FL (US)

(72) Inventors: Justin Stewart, Deerfield Beach, FL (US); Edward P. Ellers, Boca Raton, FL (US)

(73) Assignee: Tyco Fire & Security GmbH, Neuhausen Am Rheinfall (CH)

(21) Appl. No.: 15/215,653

(22) Filed: Jul. 21, 2016

Related U.S. Application Data
(60) Provisional application No. 62/196,474, filed on Jul. 24, 2015.

(51) Int. Cl. H02G 3/22; B29C 65/56; B29C 65/70; H02G 1/00; B29C 65/48

(52) U.S. Cl. CPC H02G 3/22; H02G 1/005; B29C 65/48; B29C 65/70; B29C 65/56; B29L 2031/34

(57) ABSTRACT

An apparatus (100) comprising: first and second structural parts (102, 104) that are formed of a rigid material or a semi-rigid material; and a bond comprising a first adhesive (304) and at least one conductive member (502) disposed in a bonding area (306) between the first and second structural parts so as to securely couple the first and second structural parts together. The cure time of the first adhesive is decreased and a strength of the bond is increased during a bonding process by increasing a temperature of the first adhesive using the conductive member having electricity traveling therethrough.

### CROSS-REFERENCE TO RELATED APPLICATIONS

This application claims priority to U.S. Patent Application No. 62/196,474 filed on Jul. 24, 2015. The content of the above application is incorporated by reference in its entirety.

### FIELD OF THE INVENTION

This document relates generally to bonding elements. More particularly, this document relates to internal conductive elements for bonding structure entities.

### BACKGROUND OF THE INVENTION

For products that require bonding between two mated parts, options for achieving the bond can be limited for manufacturing. Typically, these bonding processes include ultrasonic welding, adhesive bonding, or some other form of fusion. This bond is achieved by either a chemical reaction or a thermal transfer between two materials.

### SUMMARY

The present document generally relates to a method for creating a bonded structure. The method involves: applying an adhesive to a bonding area of each one of two structural elements; placing a conductive wire into the bonding area of the first structure element; placing a second structural element of the two structural elements on top of the first structural element; inserting screws into threaded apertures formed in the first and second structural elements to hold the first and second structural elements together; establishing an electrical connection between the conductive wire and a power source; increasing a temperature of the adhesive by supplying power from the power source to the conductive wire; and allowing the adhesive to cure.

In some scenarios, a first structural element of the two structural elements is placed on an assembly fixture, prior to placing the conductive wire into the bonding area. A clamping mechanism of the assembly fixture is engaged so as to clamp the first and second structural elements together prior to screw insertion. The conductive wire is disconnected from the power source after completion of the adhesive's cure cycle. The first and second structural elements which are bonded to each other are removed from the assembly fixture, subsequent to completion of the adhesive's cure cycle.

The present disclosure also concerns an apparatus (e.g., a pedestal detection system). The apparatus comprises: first and second structural parts that are formed of a rigid material or a semi-rigid material (e.g., a fiber-reinforced thermoset material); and a bond comprising a first adhesive and at least one conductive member (e.g., a wire or plate) disposed in a bonding area (e.g., a track) between the first and second structural parts so as to securely couple the first and second structural parts together. A cure time of the first adhesive is decreased and a strength of the bond is increased during a bonding process by increasing a temperature of the first adhesive using the conductive member having electricity traveling therethrough.

In some scenarios, at least one first mechanical coupler is coupled to the first and second structural parts prior to having the electricity travel through the conductive member. The first mechanical coupler comprises a screw, a clamp, a zip tie or a tie wrap. The conductive member is disposed in a vertical section of the first and second structural parts. The at least one first mechanical coupler is disposed in a horizontal section of the first and second structural parts. The horizontal section has a second adhesive disposed thereon which has a cure time longer than the cure time of the first adhesive.

At least one second mechanical coupler (that is different than the at least one first mechanical coupler) may also be disposed on center sections of the first and second structural parts. The first mechanical coupler remains in the apparatus subsequent to installation thereof, while the at least one second mechanical coupler is removed from the apparatus upon installation thereof.

In those or other scenarios, the conductive member is connected to a power source during the first adhesive's cure cycle and disconnected from the power source after completion of the first adhesive's cure cycle. The conductive member is manually inserted into the bonding area and/or insert molded into the bonding area of the first or second structural part prior to a disposition of the first adhesive in the bonding area. The conductive member is trimmed at two opposing ends thereof. The conductive member is accessible subsequent to the bonding process to allow communication or electrical transfer between two opposing ends of the apparatus. Accordingly, the conductive member has a dual purpose of (a) decreasing a cure time of the first adhesive and (b) allowing communication or electrical transfer between two opposing ends of the apparatus while the apparatus.

### DESCRIPTION OF THE DRAWINGS

Embodiments will be described with reference to the following drawing figures, in which like numerals represent like items throughout the figures, and in which:

FIG. 1 is an illustration of an exemplary Pedestal Detection System (“PDS”).

FIG. 2 is a flow diagram of an exemplary boding process.

FIG. 3 is an illustration showing an adhesive being applied to bonding areas of a PDS's structural elements.

FIG. 4 is an illustration showing a PDS's structural element being placed on an assembly fixture.

FIG. 5 is an illustration showing a heating (or conductive) wire being placed in a track or bonding area of the first structural element disposed on the assembly fixture.

FIG. 6 is an illustration showing a second structural element placed on top of the first structural element.

FIG. 7 is an illustration of clamping mechanisms being engaged.

FIG. 8 is an illustration showing screws being inserted into threaded apertures formed in a PDS's structural elements.

FIG. 9 is an illustration showing an electrical connection being established between a heating wire and a power source.

FIG. 10 is an illustration showing a power source being turned on.

FIG. 11 is an illustration an end of a heating wire being trimmed.

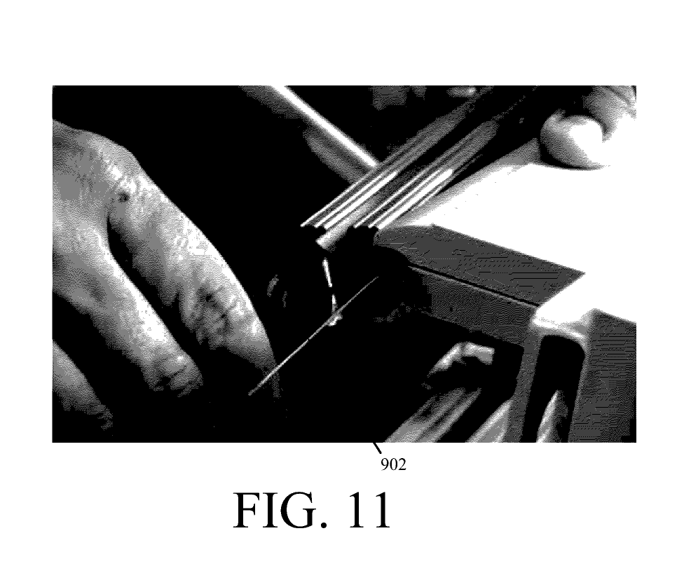

FIG. 12 is an illustration of a snap mechanism being coupled to two bonded structural elements.

FIG. 13 is a cross-sectional view of two structural elements coupled to each other.

FIG. 14 is an illustration showing a heating wire causing heating of a surrounding area so as to accelerate an adhesive's cure cycle.

FIG. 15 provides illustrations of exemplary fully assembled Pedestal Detection Systems (“PDS s”).

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present disclosure concerns systems and methods for bonding two parts together. The two parts can include, but are not limited to, structural chassis. Structural chassis that are bonded together provide for the mechanical and electrical integrity of a product. The concept discussed herein increases the strength of the bond between the two structural chassis, while dramatically decreasing the amount of time required to achieve the bond.

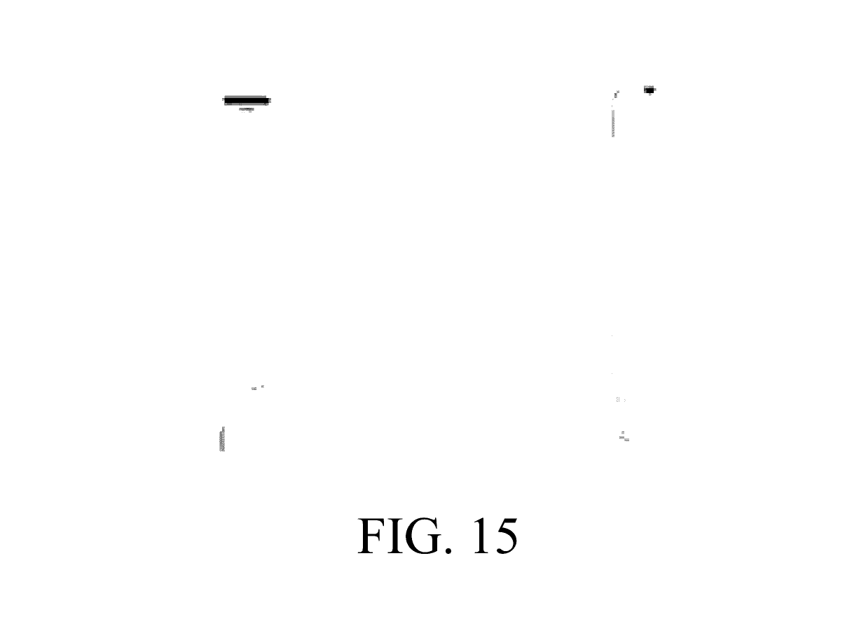

In some scenarios, the bonding process is used to form a PDS 100. PDSs are well known in the art, and therefore will not be described in detail herein. Still, it should be understood that a PDS is used in Electronic Article Surveillance (“EAS”) systems for theft detection and/or prevention in retail store environments. The PDS provides antennas for transmitting interrogation signals to active EAS tags in a detection zone (typically provided at an exit/entrance of a store) and receiving response signals from the active EAS tags. In response to the response signal's reception, an alarm may be issued by the EAS system to notify store personnel of a potential theft. Schematic illustrations of exemplary fully assembled PDS s are provided in FIG. 15. PDSs are also referred to in the art as pedestals or EAS pedestals, as evident from U.S. Pat. No. 9,342,968 to Allen et al. (“the '968 patent”).

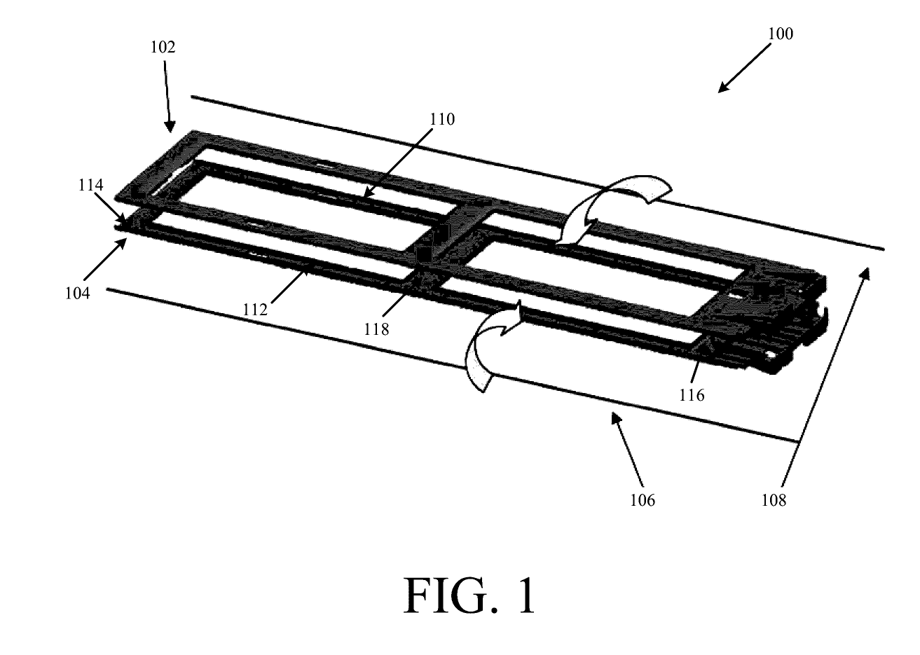

As shown in FIG. 1, the PDS 100 comprises two structural elements 102 and 104. The structural elements 102 and 104 are formed of a rigid or semi-rigid material, such as plastic. In some scenarios, the structural elements 102 and 104 are composed of a fiber-reinforced thermoset material, and therefore melting the plastic to achieve a bond (via ultrasonic welding, laser welding, etc.) is not possible. Accordingly, the novel bonding process described herein is used to achieve a bond between certain portions of the two structural elements 102, 104.

During the novel bonding process, the structural elements 102 and 104 are bonded together using an adhesive (e.g., a urethane adhesive). The adhesive includes, but is not limited to, a two part urethane adhesive having a product code 2570 which is available from Lord® Corporation of Cary, N.C.

The adhesive employed here typically takes an undesirably long time to cure. As such, certain steps are performed to reduce the time it takes to bond at least a portion of the two structural elements 102 and 104 together, as well as increase the strength of the bond. These steps involve disposing heating or conductive wires 106 and 108 in a bonding area between the two structural elements 102 and 104. When the heating or conductive wires 106 and 108 are coupled to an electrical power source, they increase in temperature. Consequently, the adhesive also rises in temperature. This temperature rise results in a decreased amount of time required for the adhesive to cure. In some scenarios, twenty (20) Volts AC at five (5) Amps is used. The electrical power source supplies current to the conductive wires 106 and 108. The present solution is not limited by the specified voltage and current values. Different voltages and amps can be supplied to the conductive wires 106 and 108 in accordance with a particular application.

In some scenarios, the heating or conductive wires 106 and 108 are only disposed in vertical sections 110, 112 of the structural elements 102 and 104. The adhesive disposed in the horizontal sections is the same as or different than the adhesive disposed in the vertical sections of the structural elements 102, 104. In all cases, the cure time of the adhesive disposed in vertical sections 110, 112 is improved. However, the cure time of the adhesive disposed in horizontal sections 114, 116, 118 is relatively long (e.g., a 3.5 hour cure time) as compared to that of the adhesive used in the vertical sections 110, 112.

Since the cure time of the adhesive in horizontal sections 114, 116, 118 is relatively long, mechanical mechanisms are employed to ensure that the horizontal sections of the structural elements 102, 104 do not come apart during the remaining manufacturing process. The mechanical mechanisms can include, but are not limited to, screws, clamps, zip ties, and tie wraps. The clamps, zip ties and tie wraps may be employed for aesthetic reasons (i.e., to facilitate the visual absence of screws or other mechanical fasteners on select portions of the PDS 100).

For example, screws are used to securely couple top and bottom horizontal sections 114, 116 of the structural elements 102 and 104 together. In contrast, a clamp, zip tie or tie wrap is used to couple center sections 118 of the structural elements 102 and 104 together. The screws are left in the structure elements after completion of the manufacturing process. However, the clamp, zip tie or tie wrap remains secured and included in the product packaging, and is removed at the time of installation. The present invention is not limited to the particulars of this example. Any known or to be known coupler can be used here provided that the coupler is removable at least during installation of a PDS.

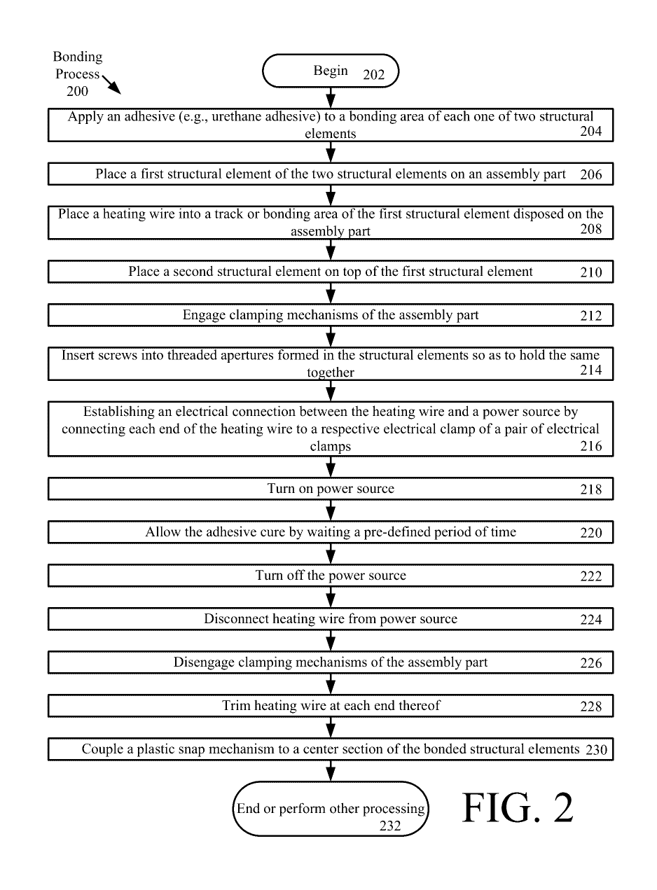

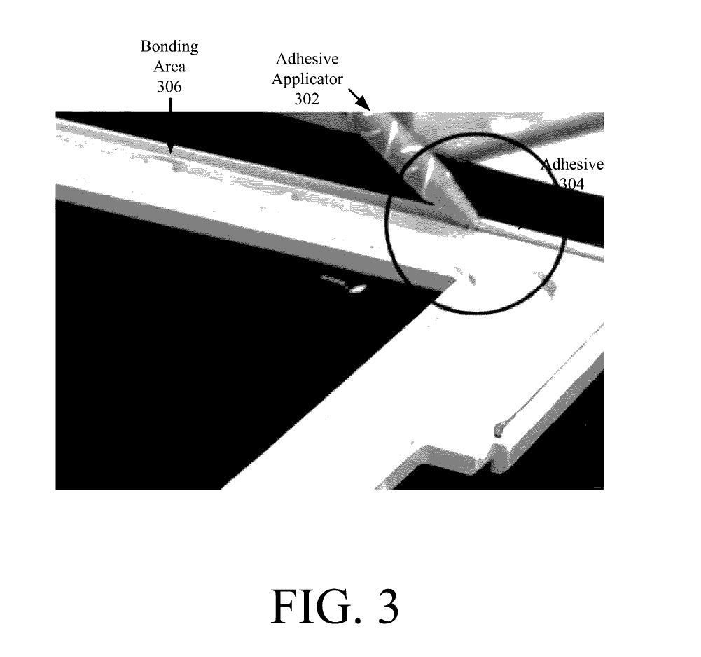

A flow diagram of an exemplary boding process 200 is provided in FIG. 2. As shown in FIG. 2, the bonding process 200 begins with step 202 and continues with step 204 where an adhesive (e.g., adhesive 304 of FIG. 3) is applied to the bonding areas (e.g., bonding area 306 of FIG. 3) of a PDS's structural elements (e.g., structural elements 102 and 104 of FIG. 1) using an adhesive applicator (e.g., adhesive applicator 302 of FIG. 3). In some scenarios, the adhesive comprises a urethane adhesive. Other known or to be known adhesives can be employed in step 204 in addition to or as an alternative to the urethane adhesive.

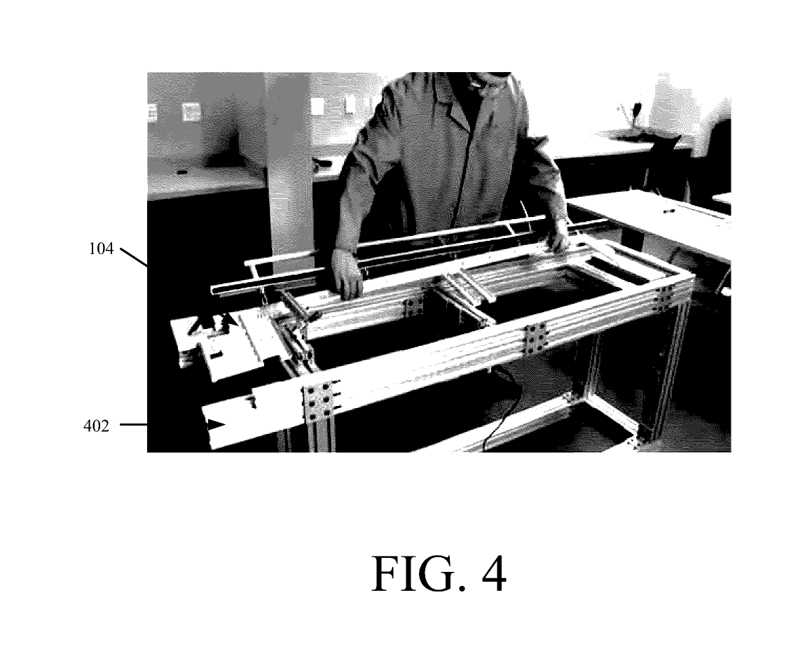

In a next step 206, a first structural element of the two structural elements (e.g., structural element 104 of FIG. 1) is placed on an assembly fixture (e.g., assembly fixture 402 of FIG. 4). The assembly fixture is designed to facilitate the production of a PDS at least by securely supporting and locating (position in a specific location or orientation) the structural elements (relative to each other) to ensure that all PDSs produced using the assembly fixture will maintain conformity and interchangeability.

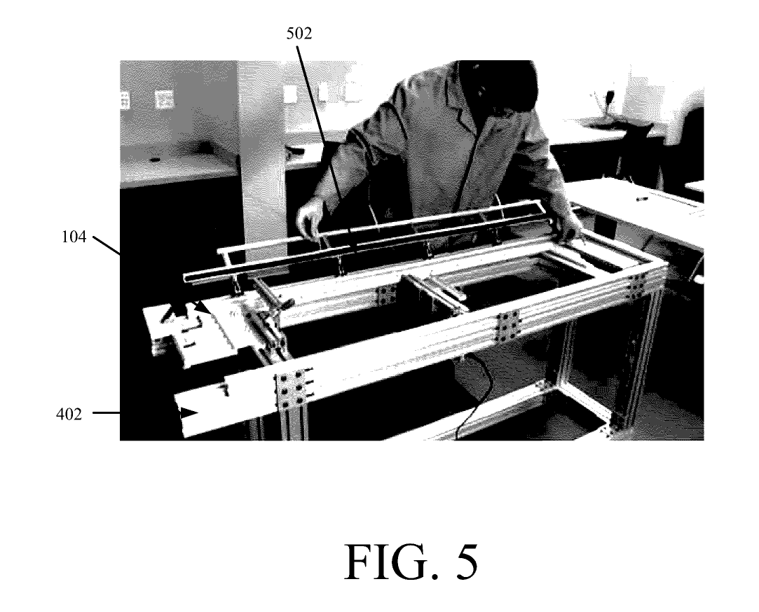

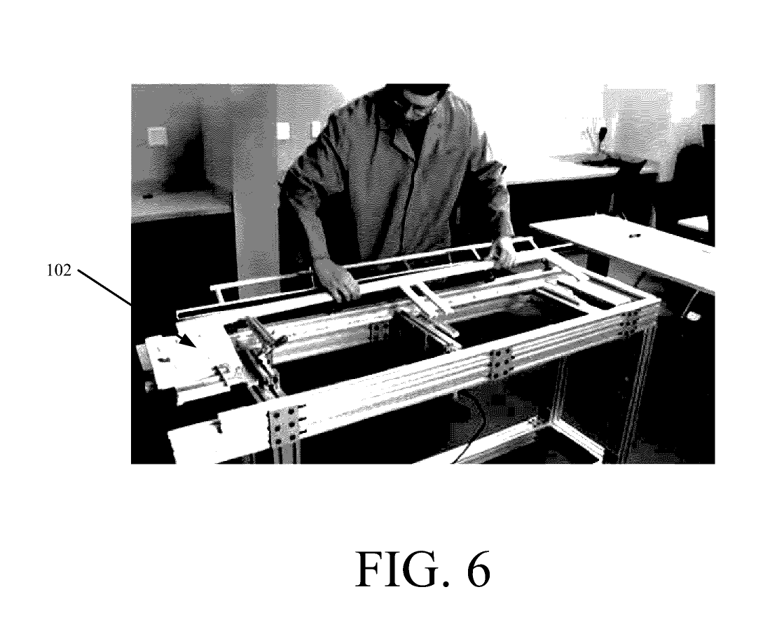

A heating or conductive wire (e.g., heating wire 502 of FIG. 5) is then placed in a bonding area (e.g., bonding area 306 of FIG. 3) of the first structural element disposed on the assembly fixture, as shown by step 208. The heating or conductive wire can include, but is not limited to, a Nichrome wire or Tungsten wire. The bonding area can include, but is not limited to, a track or a concave depression/aperture/surface. The heating wire may be placed manually in the bonding area. Alternatively, the heating wire may be insert molded into the structural elements. Insert molding is well known in the art, and therefore will not be described herein. In some scenarios, step 208 is performed prior to step 204 instead of subsequent to step 204. Upon completing step 208, step 210 is performed where the second structural element is placed on top of the first structural element as shown in FIG. 6.

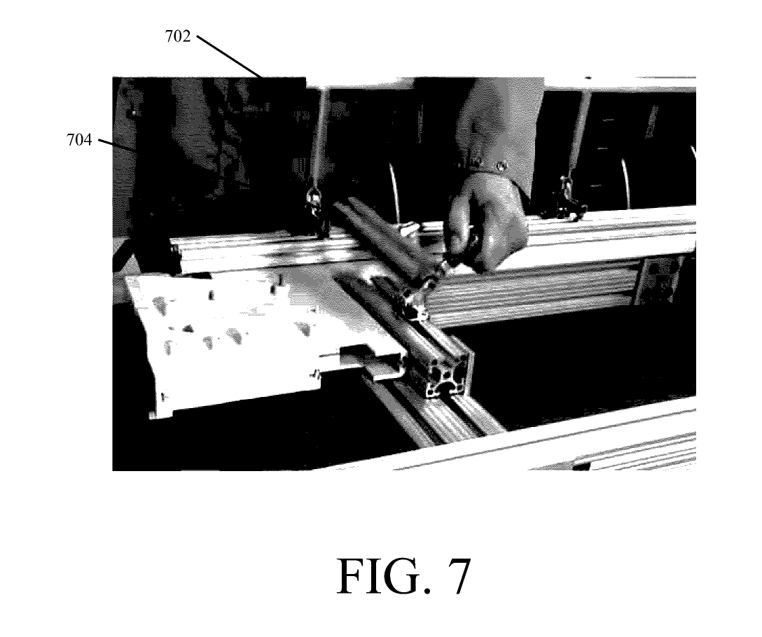

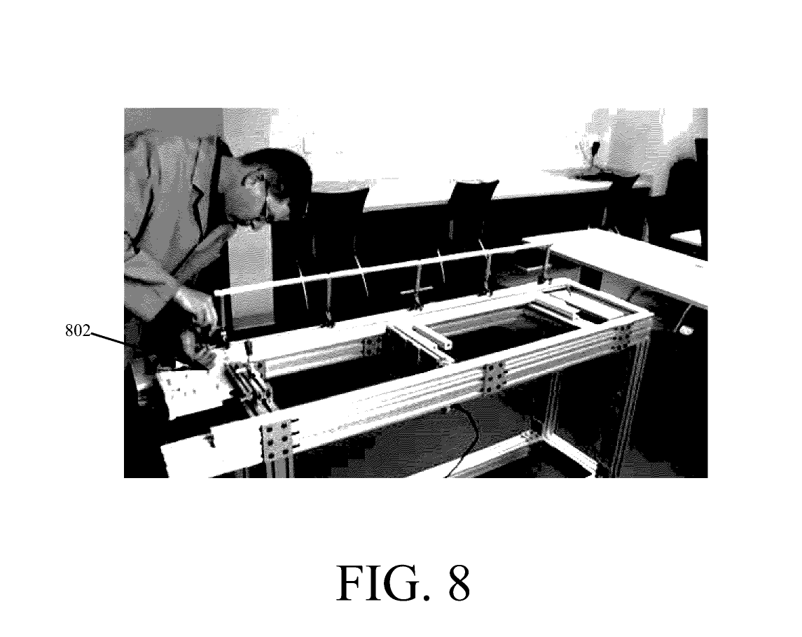

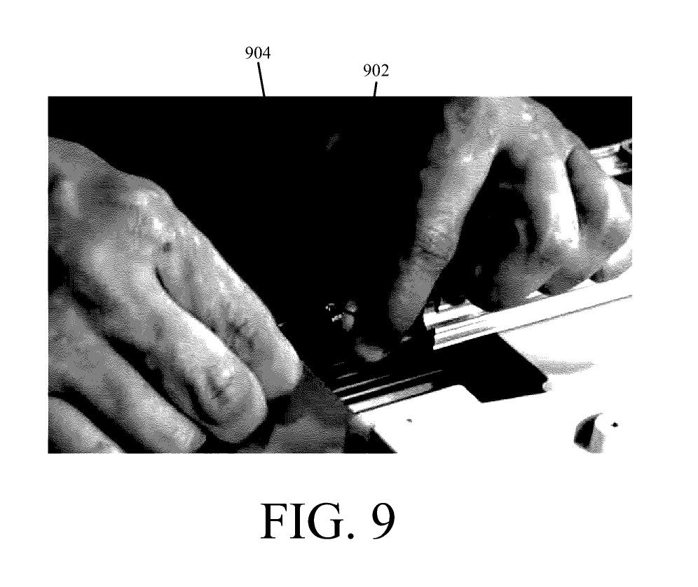

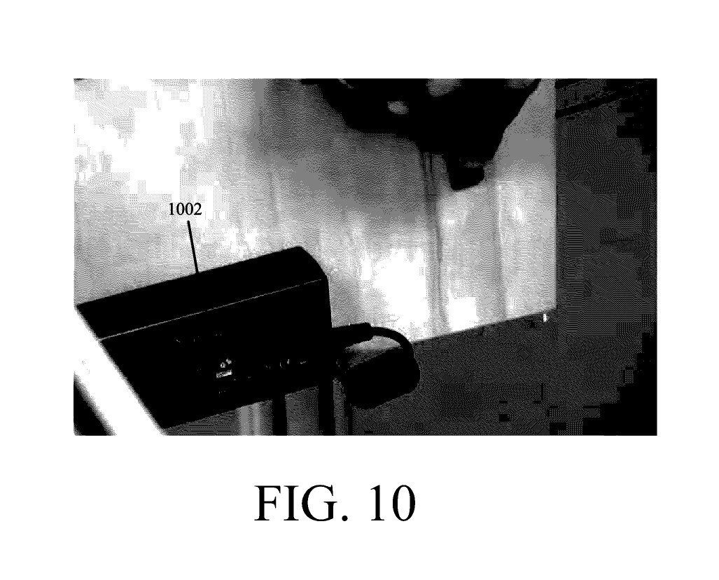

Next in step 212, clamping mechanisms (e.g., clamping mechanisms 702 and 704 of FIG. 7) of the assembly fixture are engaged. First mechanical couplers (e.g., screw 802 of FIG. 8) are then inserted into threaded apertures formed in the structural elements so as to hold the same together, as shown by step 214. In a next step 216, an electrical connection is established between the heating or conductive wire (e.g., heating wire 502 of FIG. 5) and a power source (e.g., power source 1002 of FIG. 10). The electrical connection is established by connecting each end (e.g., end 902 of FIG. 9) of the heating wire to a respective electrical clamp (e.g., electrical clamp 904 of FIG. 9) of a pair of electrical clamps. The power source is then turned on in step 218, as shown in FIG. 10. The power source supplies twenty (20) Volts AC and five (5) Amps to the conductive wire. In effect, the temperature of the heating wire increases. As a result, the temperature of the adhesive disposed therewith in the bonding area also increases. The adhesive is allowed to cure by waiting a pre-defined period of time (e.g., five minutes), as shown by step 220.

Upon expiration of the pre-defined period of time, the power source is turned off and the heating wire is disconnected from the power source, as shown in steps 222 and 224. The clamping mechanisms of the assembly fixture are then disengaged in step 226. The heating wire is then trimmed in step 228 at each end thereof, as shown in FIG. 10. This trimming is achieved using wire cutters. Wire cutters are well known in the art. Any known or to be known wire cutters can be used herein without limitation. The rest of the heating wire remains permanently disposed within the bonded structural elements. As such, the heating wire can be accessed at the post production stage to serve as a single or multiple strand conductor, allowing for communication or electrical transfer between the top and bottom of the PDS when in use. Consequently, the heating or conductive wires have at least a dual purpose of (a) decreasing a cure time of the adhesive disposed in the bonding area therewith and (b) allowing communication or electrical transfer between two opposing ends of the apparatus while the apparatus is in use.

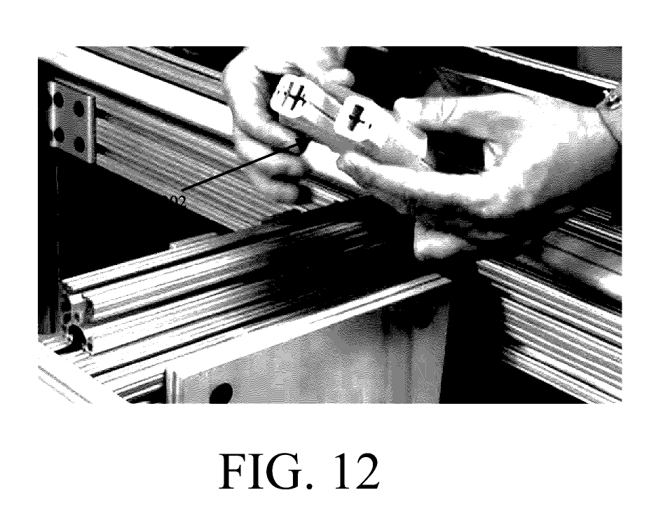

A snap mechanism (e.g., snap mechanism 1202 of FIG. 12) is then coupled to a center section of the bonded structural elements, as shown by step 230. The snap mechanism remains coupled to the bonded structural elements through the remainder of the manufacturing process. The snap mechanism is provided to ensure that the center section of the bonded structural elements does not come apart during the remaining manufacturing process of the PDS. The snap mechanism is employed for aesthetic reasons, i.e., to facilitate the visual absence of screws or other mechanical fasteners on the center section of the bonded structural elements. Subsequent to completing step 230, step 232 is performed where the bonding process 200 ends or other processing is performed (e.g., to complete fabrication of an EAS pedestal).

By applying heat to the adhesive, a faster cure is achieved and less time is needed to complete the bonding process. Notably, the novel bonding process differs from conventional bonding processes in the following ways: (1) a different adhesive is employed in the novel bonding process; (2) a heating wire is used to decrease the cure time of the adhesive; (3) an assembly fixture is employed which comprises clamping mechanisms; (4) first mechanical couplers (e.g., retaining screws) are used to hold the two structural elements together throughout a portion of the bonding process; and (5) a second mechanical coupler (e.g., a snap mechanism) is used to prevent the center portion of the two bonded structural elements from being pulled apart during the remainder of the manufacturing process. Features (1)-(5) collectively provide a 91% percent decrease in the overall time needed to manufacture a PDS with minimal additional cost (e.g., an additional few dollars).

The above described bonding process can be applied to a number of different applications. The bonding process can be achieved using different materials and processing steps aside from what is presented herein. For example, if a chassis is formed of a thermoplastic material, there is no need for the adhesive. The boding area surrounding the heating wire would melt and create a knit line. Alternatively, the heating wire could be replaced with a plate or other object having a unique geometry so as to maximize the effectiveness of the thermal transfer.

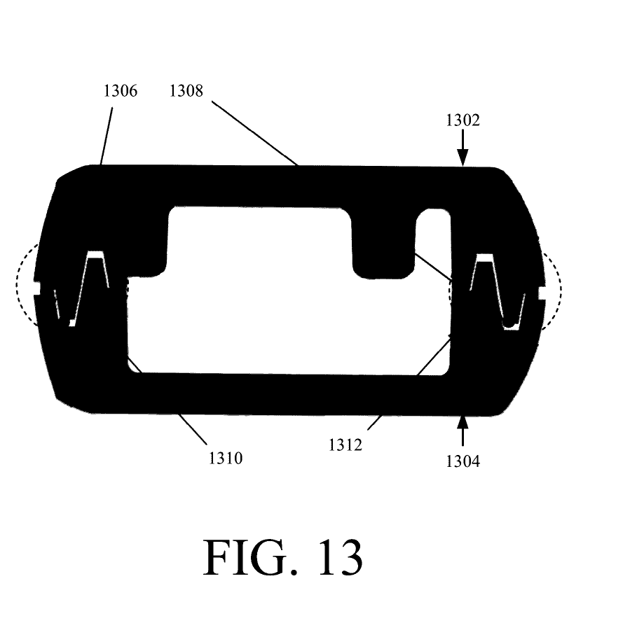

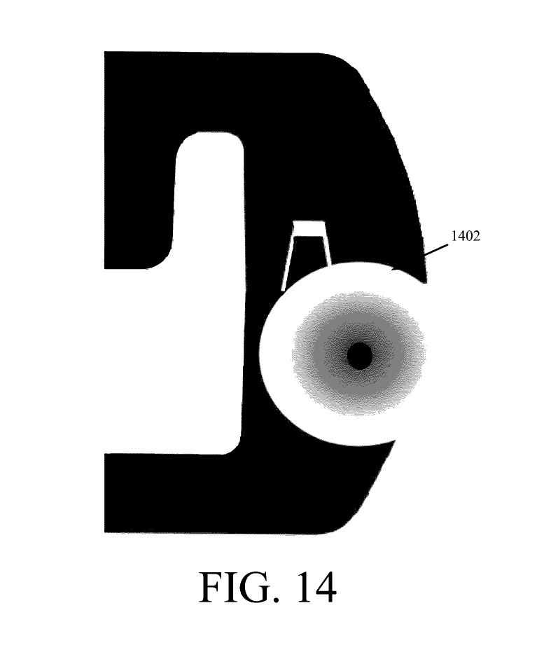

Referring now to FIGS. 13-14, there is provided cross-sectional views of two structural elements 1302 and 1304 coupled to each other. A heating wire 1306, 1308 is disposed within a respective bonding are 1310, 1312 formed between the two structural elements. Each heating wire causes heating of the surrounding area 1402, thereby accelerating the adhesive's cure cycle.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. An apparatus, comprising:
first and second structural parts that are formed of a rigid material or a semi-rigid material; and
a bond comprising a first adhesive and at least one conductive member disposed in a bonding area between the first and second structural parts so as to securely couple the first and second structural parts together;
wherein a cure time of the first adhesive is decreased and a strength of the bond is increased during a bonding process by increasing a temperature of the first adhesive using the conductive member having electricity traveling therethrough.

2. The apparatus according to claim 1, wherein the rigid or semi-rigid material comprises a fiber-reinforced thermoset material.

3. The apparatus according to claim 1, further comprising at least one first mechanical coupler coupled to the first and second structural parts prior to having the electricity travel through the conductive member.

4. The apparatus according to claim 3, wherein the at least one first mechanical coupler comprises a screw, a clamp, a zip tie or a tie wrap.

5. The apparatus according to claim 3, wherein the conductive member is disposed in a vertical section of the first and second structural parts and the at least one first mechanical coupler is disposed in a horizontal section of the first and second structural parts.

6. The apparatus according to claim 5, wherein the horizontal section has a second adhesive disposed thereon which has a cure time longer than the cure time of the first adhesive.

7. The apparatus according to claim 5, further comprising at least one second mechanical coupler that is different than the at least one first mechanical coupler and that is disposed on center sections of the first and second structural parts.

8. The apparatus according to claim 7, wherein the at least one first mechanical coupler remains in the apparatus subsequent to installation thereof and the at least one second mechanical coupler is removed from the apparatus upon installation thereof

9. The apparatus according to claim 1, wherein the apparatus is a pedestal detection system.

10. The apparatus according to claim 1, wherein the conductive member is connected to a power source during the first adhesive's cure cycle and disconnected from the power source after completion of the first adhesive's cure cycle.

11. The apparatus according to claim 1, wherein the bonding area includes a track.

12. The apparatus according to claim 1, wherein the conductive member is insert molded into the bonding area of the first or second structural part prior to a disposition of the first adhesive in the bonding area.

13. The apparatus according to claim 1, wherein the conductive member is trimmed at two opposing ends thereof.

14. The apparatus according to claim 1, wherein the conductive member is accessible subsequent to the bonding process to allow communication or electrical transfer between two opposing ends of the apparatus.

15. The apparatus according to claim 1, wherein the conductive member has a dual purpose of (a) decreasing a cure time of the first adhesive and (b) allowing communication or electrical transfer between two opposing ends of the apparatus.
